(19) United States
(12) Patent Application Publication
(10) Pub. No.: US 2023/0302594 A1
(43) Pub. Date: Sep. 28, 2023

(54) RAPID FEED SPLIT LEAD NUT SYSTEM

(71) Applicant: Team Industrial Services, Inc., Sugar Land, TX (US)

(72) Inventors: Jimi WADE, Cumbria (GB); Mark KING, Cumbria (GB)

(21) Appl. No.: 18/022,019

(22) PCT Filed: Aug. 18, 2021
(86) PCT No.: PCT/US2021/046540

§ 371 Date: Feb. 17, 2023

Related U.S. Application Data
(60) Provisional application No. 63/074,277, filed on Sep. 3, 2020.

(51) Int. Cl. B23Q 5/40; F16H 25/24; F16H 25/20

(52) U.S. Cl. CPC B23Q 5/40; F16H 25/24; F16H 25/2006

(57) ABSTRACT

A technique facilitates operation of a split lead nut system which may be used in combination with a lead screw. The split lead nut system may be constructed with a split lead nut having a plurality of lead nut sections, e.g. two lead nut sections. The lead nut sections may be selectively released, via a clasp mechanism, to enable separation of the lead nut sections. When the lead nut sections are separated, the split lead nut disengages from the lead screw such that the split lead nut and the corresponding lead screw may be rapidly shifted with respect to each other. This allows a tool coupled with the lead nut to be rapidly repositioned. Once at a desired position, the lead nut sections may be closed and reconnected with the corresponding lead screw to enable the desired, controlled movements of the tool via rotation of the lead screw.

### CROSS-REFERENCE TO RELATED APPLICATION

The present document is based on and claims priority to U.S. Provisional Application Ser. No. 63/074,277, filed Sep. 3, 2020, which is incorporated herein by reference in its entirety.

### FIELD OF DISCLOSURE

In general, the disclosure describes a split lead nut system which may be used in combination with a lead screw operated to shift a tool on a variety of machines. The split lead nut system may be selectively opened and released from the lead screw to enable rapid feeding of the tool along the lead screw.

### BACKGROUND OF DISCLOSURE

Many types of machines use lead screws to advance or retract a tool utilized for performing a desired operation. For example, the tool may be coupled with a lead nut mounted about a lead screw such that rotation of the lead screw causes linear movement of the lead nut and thus linear movement of the tool. According to certain cutting applications, lead screws may be selectively rotated relative to the corresponding lead nuts to advance or retract a cutting tool when performing a metal cutting operation or other type of cutting operation. However, the advance or retract movement of the tool is dictated by the feed rate of the lead screw and this can cause relatively slow transition of the tool over larger distances, e.g. when setting the tool relative to an object to be operated on by the tool. Attempts have been made to construct a releasable lead nut, however such attempts have not been successful in achieving the desired simplicity and speed for use in various machine operations.

What is needed is an improved lead nut system that may be simply and rapidly released from the lead screw to enable rapid repositioning of a tool.

### SUMMARY

This summary is provided to introduce a selection of concepts that are further described below in the detailed description. However, many modifications are possible without materially departing from the teachings of this disclosure. Accordingly, such modifications are intended to be included within the scope of this disclosure as defined in the claims. This summary is not intended to identify key or essential features of the claimed subject matter, nor is it intended to be used as an aid in limiting the scope of the claimed subject matter.

An embodiment of the present disclosure provides a split lead nut system which may be used in combination with a lead screw. The split lead nut system may be constructed with a split lead nut having a plurality of lead nut sections, e.g. two lead nut sections. The lead nut sections may be selectively released via a clasp mechanism to enable separation of the lead nut sections. When the lead nut sections are separated, the split lead nut disengages from the lead screw such that the split lead nut and the corresponding lead screw may be rapidly shifted with respect to each other in a linear direction. This allows a tool coupled with the lead nut to be rapidly repositioned. Once at a desired position, the lead nut sections may be closed and reengaged with the corresponding lead screw to enable the desired, controlled movements of the tool via rotation of the lead screw.

### BRIEF DESCRIPTION OF THE FIGURES

Certain embodiments of the disclosure will hereafter be described with reference to the accompanying drawings, wherein like reference numerals denote like elements. It is emphasized that, in accordance with standard practice in the industry, various features are not drawn to scale. In fact, the dimensions of various features may be arbitrarily increased or reduced for clarity of discussion. It should be understood, however, that the accompanying figures illustrate the various implementations described herein and are not meant to limit the scope of various technologies described herein, and:

FIG. 1 is an orthogonal view of an example of a split lead nut system in a closed position, in accordance with embodiments of the present disclosure;

FIG. 2 is an orthogonal view of an example of a split lead nut system in an open position, in accordance with embodiments of the present disclosure;

FIG. 3 is a cross-sectional view of an example of a split lead nut system having lead nut sections in a closed position, in accordance with embodiments of the present disclosure;

FIG. 4 is an orthogonal view of an example of a split lead nut in a closed position and engaged with a corresponding lead screw of a machine, in accordance with embodiments of the present disclosure;

FIG. 5 is an orthogonal view of an example of a split lead nut in an open position and disengaged with a corresponding lead screw of a machine, in accordance with embodiments of the present disclosure;

FIG. 6 is an orthogonal view of an example of a split lead nut in a closed, engaged position about a lead screw and coupled with a tool of a machine, in accordance with embodiments of the present disclosure; and

FIG. 7 is an orthogonal view of an example of a split lead nut in an open, disengaged position about a lead screw to enable rapid movement of the split lead nut and a corresponding tool with respect to a support structure of a corresponding machine, in accordance with embodiments of the present disclosure.

### DETAILED DESCRIPTION

In the following description, numerous details are set forth to provide an understanding of some embodiments of the present disclosure. It is to be understood that the following disclosure provides many different embodiments, or examples, for implementing different features of various embodiments. Specific examples of components and arrangements are described below to simplify the disclosure. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed. However, it will be understood by those of ordinary skill in the art that the system and/or methodology may be practiced without these details and that numerous variations or modifications from the described embodiments are possible. This description is not to be taken in a limiting sense, but rather made merely for the purpose of describing general principles of the implementations. The scope of the described implementations should be ascertained with reference to the issued claims.

As used herein, the terms “connect”, “connection”, “connected”, “in connection with”, and “connecting” are used to mean “in direct connection with” or “in connection with via one or more elements”; and the term “set” is used to mean “one element” or “more than one element”. Further, the terms “couple”, “coupling”, “coupled”, “coupled together”, and “coupled with” are used to mean “directly coupled together” or “coupled together via one or more elements”. As used herein, the terms “up” and “down”; “upper” and “lower”; “top” and “bottom”; and other like terms indicating relative positions to a given point or element are utilized to more clearly describe some elements.

According to an embodiment, a split lead nut system may be used in combination with a lead screw. The split lead nut system may be constructed with a split lead nut having a plurality of lead nut sections, e.g. two lead nut sections. The lead nut sections may be selectively released via a clasp mechanism to enable separation of the lead nut sections. When the lead nut sections are separated, the split lead nut disengages from the lead screw such that the split lead nut and the corresponding lead screw may be rapidly shifted with respect to each other in a linear direction. Effectively, the feed of the lead screw may be disengaged or engaged in a quick operation. This allows a tool coupled with the lead nut to be rapidly traversed and repositioned along the lead screw. Once at a desired position, the lead nut sections may be closed and reengaged with the corresponding lead screw to enable the desired, controlled movements of the tool via rotation of the lead screw. The ability to quickly release the split lead nut facilitates disengagement and then engagement of the tool at a desired position so as to reduce working time and to enable rapid feed out in case of an emergency.

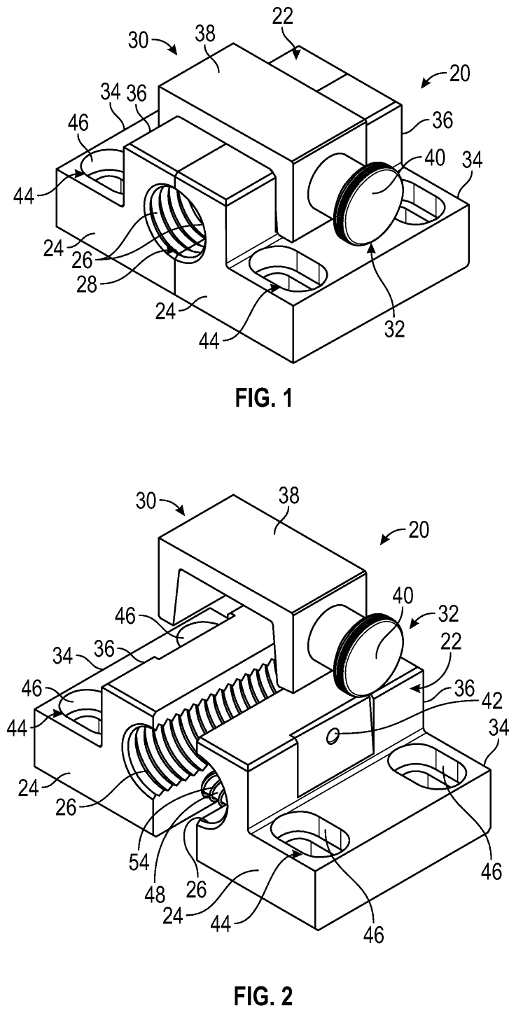

Referring generally to FIG. 1, an example of a split lead nut system 20 is illustrated. In this example, the split lead nut system 20 comprises a split lead nut 22 having a plurality of lead nut sections 24. As illustrated, the split lead nut 22 comprises two lead nut sections 24 which may be rapidly transitioned between a closed position (see FIG. 1) and an open position (see FIG. 2). Each lead nut section 24 is constructed with a threaded region 26 arranged to form a threaded bore 28 when the split lead nut 22 is in the closed position. As explained in greater detail below, the threaded bore 28 is sized to receive a corresponding threaded lead screw.

When in the closed position, the split lead nut 22 is secured in this closed position by a clasp mechanism 30. The clasp mechanism 30 comprises an actuator 32 which may be selectively actuated to release the clasp mechanism 30, thus enabling rapid opening of the split lead nut 22 via separation of the lead nut sections 24 as illustrated in FIG. 2. According to one embodiment, each lead nut section 24 comprises a base portion 34 joining an angle portion 36. By way of example, the angle portion 36 may extend from the base portion 34 at a generally 90° angle. In the illustrated example, the clasp mechanism 30 comprises a clasp 38 which may be generally U-shaped and sized to slide over adjacent angle portions 36 when the lead nut sections 24 are in the closed position.

The actuator 32 secures clasp 38 about the lead nut sections 24 and thus holds the split lead nut 22 in the closed position. By way of example, the actuator 32 may comprise a plunger having a portion extending through a wall of the clasp 38 for engagement with a corresponding opening 42 in the adjacent lead nut section 24. In the illustrated example, the opening 42 is a threaded opening for threadably receiving an end of the plunger 40. However, the plunger 40 may have other configurations such as a spring-loaded pin configuration arranged to spring bias a pin into the corresponding opening 42. In some embodiments, each lead nut section 24 may comprise an opening 42 and the clasp 38 may have corresponding passages 42 to allow use of plunger 40 from either side of the clasp 38.

To facilitate attachment of a tool to the split lead nut 22, the split lead nut 22 may comprise tool mounting features 44. The tool mounting features 44 may have a variety of configurations depending on the type, size, and weight of the tool. In one example, the tool mounting features 44 comprise elongate openings 46 formed through base portions 34 of lead nut sections 24. The openings 46 may be elongated to enable shifting of the lead nut sections 24 as the split lead nut 22 is transitioned between closed and open positions.

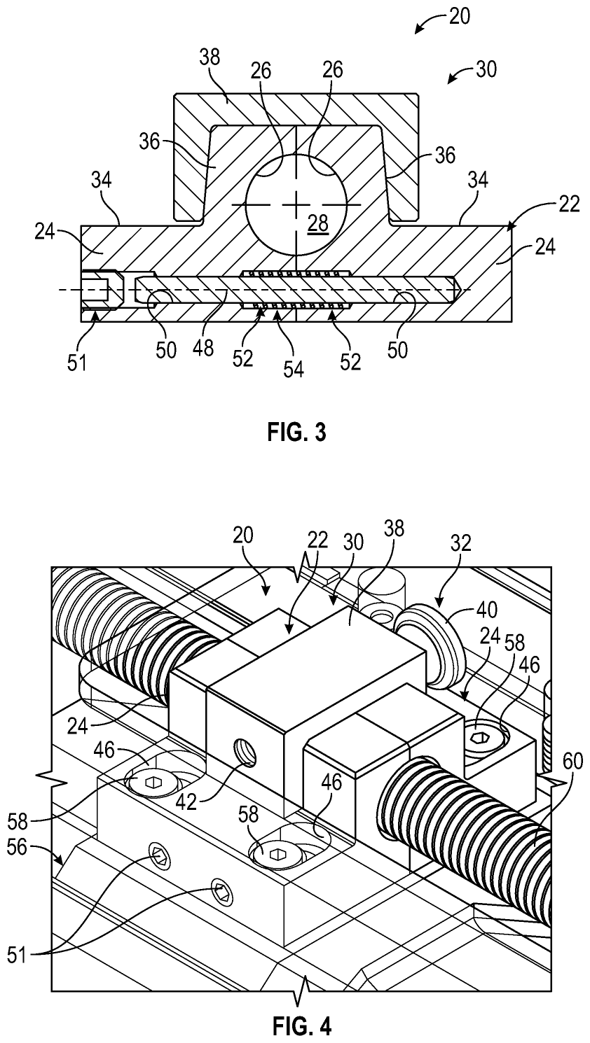

In some embodiments, the lead nut sections 24 may be movably coupled with each other. For example, the two lead nut sections 24 may be slidably mounted on at least one pin 48, e.g. two pins 48, to facilitate movement with respect to each other between the closed and open positions. As further illustrated in FIG. 3, the pin(s) 48 may be slidably received in corresponding passages 50 formed in the lead nut sections 24. The passages 50 for a given pin 48 may be linearly arranged in the lead nut sections 24 and the corresponding pin 48 may be secured therein via a suitable plug 51, e.g. a set screw.

Additionally, each passage 50 may comprise an expanded diameter region 52 for receiving a spring 54, e.g. a coil spring. When the split lead nut 22 is transitioned to the closed position, as illustrated in FIG. 3, each spring 54 is compressed along its corresponding pin 48 so as to bias the lead nut sections 24 away from each other. In other words, the spring or springs 54 may be used to bias the split lead nut 22 to an open position (see FIG. 2). Effectively, the spring(s) 54 help open the split lead nut 22 when repositioning of a tool is desired.

Referring generally to FIG. 4, the split lead nut system 20 is illustrated as connected with a tool 56 via appropriate fasteners 58 inserted through elongate openings 46 for engagement with the tool 56. As illustrated, the split lead nut 22 is closed about a threaded lead screw 60 and threadably engaged with the lead screw 60 via threaded sections 26 along bore 28 such that rotation of the lead screw 60 in one direction or the other causes relative movement of the split lead nut 22 and thus the tool 56 linearly along the lead screw 60. Rotation of the lead screw 60 in one direction causes advancement of the split lead nut 22 and corresponding tool 56 while rotation of the lead screw 60 in the opposite direction causes retraction of the split lead nut 22 and corresponding tool 56.

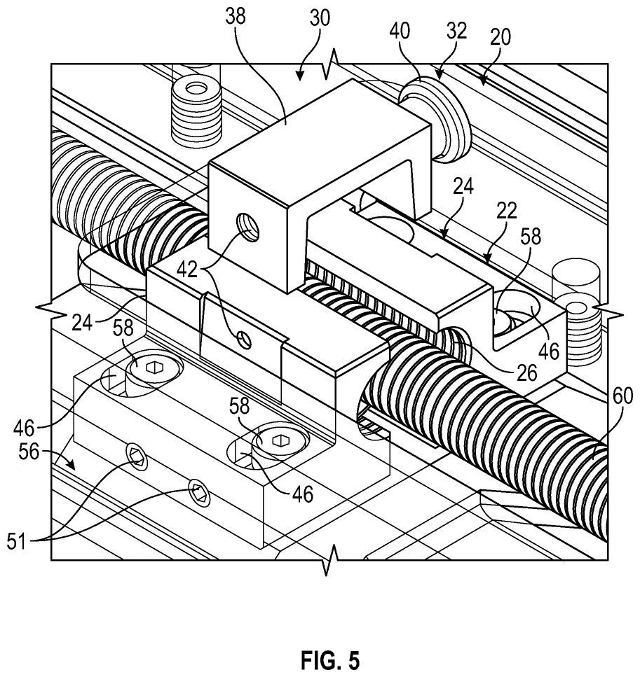

If the tool 56 is to be repositioned rapidly, the clasp mechanism 30 is released to enable separation of lead nut sections 24, as illustrated in FIG. 5. If springs 54 are employed, the springs 54 help bias the split lead nut 22 into this open position. According to the embodiment illustrated, the clasp mechanism 30 is released via actuation of actuator 32. For example, if actuator 32 comprises plunger 40, the plunger 40 may be simply rotated to unthread the plunger 40 from its corresponding opening 42 in the adjacent lead nut section 24. This allows the clasp 38 to be quickly lifted away from angled portions 36 of lead nut sections 24 to enable opening of the split lead nut 22.

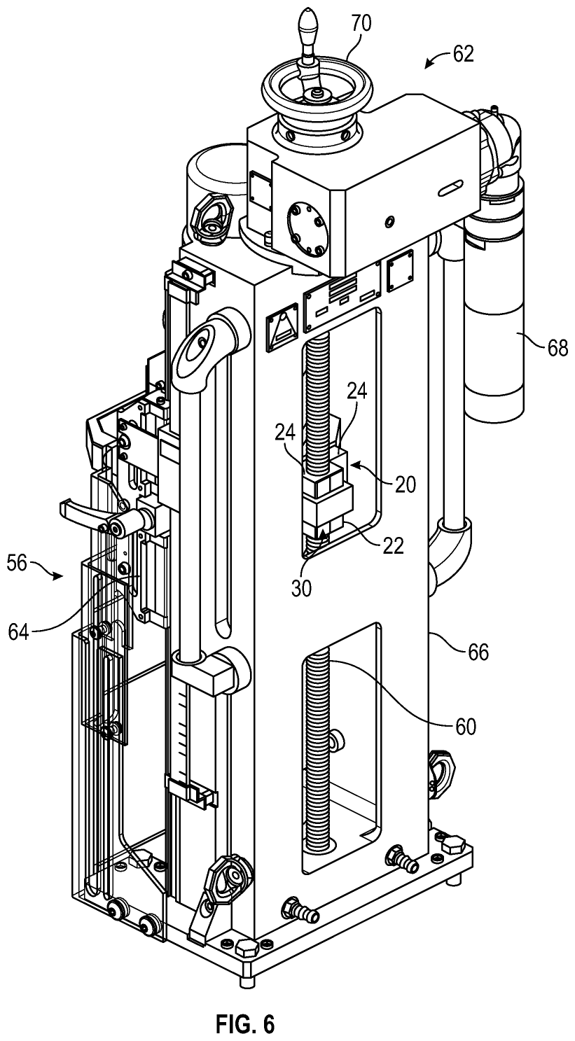

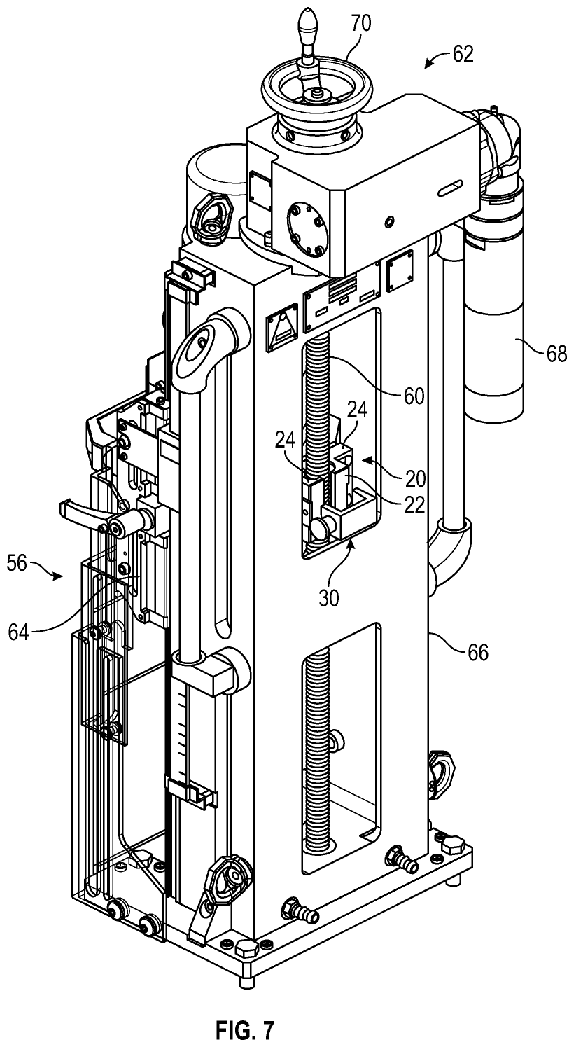

Referring generally to FIGS. 6 and 7, a specific example of tool 56 is illustrated as movably mounted on an overall machine 62. It should be noted, however, the split lead nut system 20 and corresponding lead screw 60 may be used with many types of tools 56 on a wide variety of machines 62. In the illustrated example, the tool 56 is in the form of a cutting tool 64, e.g. a drill, coupled to lead screw 60 via split lead nut system 20. In this example, machine 62 comprises a support structure 66 in which the lead screw 60 is rotatably mounted. Rotation of the lead screw 60 may be controlled by a suitable motive unit, such as a motor 68 or handcrank 70. Examples of motor 68 include electric motors, hydraulic motors, pneumatic motors, or other suitable motors.

When lead screw 60 is rotated in one direction, the split lead nut system 20 and attached cutting tool 64 move linearly in a first direction. However, as the lead screw 60 is rotated in the opposite direction, the split lead nut system 20 and attached cutting tool 64 move linearly in a second or opposite direction. In this manner, the cutting tool 64 may be advanced toward an object to be cut, e.g. drilled, or may be retracted away from the object depending on the direction of rotation of lead screw 60.

If, however, the cutting tool 64 is to be moved rapidly between disparate positions, the split lead nut 22 may simply be released and opened, as illustrated in FIG. 7. In this open position, the split lead nut sections 24 are disengaged from lead screw 60 so that cutting tool 64 may be shifted rapidly into a different position relative to lead screw 60 and support structure 66. At the new position, the split lead nut 22 may again be closed into engagement with the lead screw 60 and held in this closed, engaged position via clamp mechanism 30. The split lead nut 22 is easily and rapidly opened and closed to accommodate larger shifts in position of the cutting tool 64 or other type of tool 56.

It should be noted that split lead nut system 20 may be constructed in a variety of sizes and configurations while maintaining its ability to be rapidly shifted between closed and open positions. Additionally, the split lead nut system 20 may be used with many types of lead screws 60 incorporated into a variety of machines 62. The split lead nut system 20 also may be utilized in advancing and retracting many types of tools, including cutting tools, observation tools, sensor tools, application tools, or various other types of tools. Similarly, many types of machines 62 may be used to support the lead screw 60 and the split lead nut system 20 during performance of the desired tasks.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

What is claimed is:

1. A system for enabling rapid machine adjustment, comprising:
a split lead nut system having a split lead nut with a plurality of lead nut sections which may be selectively shifted between an open position and a closed position, the closed position positioning the plurality of lead nut sections in threaded engagement with a corresponding lead screw, the plurality of lead nut sections being held in the closed position via a clasp mechanism, the clasp mechanism comprising an actuator selectively actuatable to release the clasp mechanism to a position allowing rapid separation of the lead nut sections, thus shifting the split lead nut system to the open position in which the split lead nut system is disengaged from the corresponding lead screw.

2. The system as recited in claim 1, wherein the plurality of lead nut sections comprises two lead nut sections.

3. The system as recited in claim 1, wherein the lead nut system further comprises tool mounting features.

4. The system as recited in claim 3, further comprising a tool connected to the tool mounting features.

5. The system as recited in claim 2, wherein the two lead nut sections are slidably mounted on at least one pin to facilitate movement with respect to each other between the open and closed positions.

6. The system as recited in claim 5, wherein the at least one pin comprises two pins.

7. The system as recited in claim 5, wherein the two lead nut sections are spring biased away from each other toward the open position.

8. The system as recited in claim 1, wherein the clasp mechanism comprises a clasp; and the actuator comprises a plunger extending through a wall of the clasp for engagement with an opening in a corresponding lead nut section of the plurality of lead nut sections.

9. The system as recited in claim 8, wherein the plunger is threadably engageable with threads along the opening.

10. A system for enabling rapid machine adjustment, comprising:
a support structure;
a lead screw rotatably mounted in the support structure;
a tool; and
a split lead nut system to couple the tool to the lead screw for movement of the tool relative to the support structure, the split lead nut system comprising:
a plurality of lead nut sections which may be selectively shifted between an open position and a closed position, the closed position positioning the plurality of lead nut sections in threaded engagement with the lead screw; and
a releasable clasp mechanism actuatable to selectively release the plurality of lead nut sections from the lead screw to enable rapid shifting of the tool to a different position along the lead screw.

11. The system as recited in claim 10, wherein the split lead nut system further comprises an actuator actuatable to selectively release the releasable clasp mechanism to a position allowing rapid separation of the plurality of lead nut sections.

12. The system as recited in claim 11, wherein the plurality of lead nut sections comprises two lead nut sections slidably mounted on at least one pin to facilitate movement with respect to each other between the open and closed positions.

13. The system as recited in claim 12, wherein the two lead nut sections are spring biased away from each other toward the open position.

14. The system as recited in claim 10, wherein the tool is a cutting tool.

15. The system as recited in claim 10, further comprising a motor coupled to the lead screw to rotate the lead screw in the support structure during movement of the tool via the lead screw.

16. The system as recited in claim 10, further comprising a handcrank coupled to the lead screw to rotate the lead screw in the support structure.

17. A method, comprising:
providing a split lead nut system with a pair of lead nut sections;
positioning the split lead nut system at a desired location along a lead screw;
closing the pair of lead nut sections over the lead screw; and
securing the pair of lead nut sections in operable engagement with the lead screw via a clasp to enable movement of the split lead nut system along the lead screw via rotation of the lead screw.

18. The method as recited in claim 17, wherein securing comprises releasably securing the clasp to at least one of the lead nut sections with a plunger.

19. The method as recited in claim 17, further comprising releasing the clasp; separating the pair of lead nut sections; moving the split lead nut system to a different position along the lead screw; re-closing the pair of lead nut sections over the lead screw; and re-securing the pair of lead nut sections in operable engagement with the lead screw via the clasp.

20. The method as recited in claim 17, further comprising rotating the lead screw via a motive unit to move the split lead nut system along the lead screw.
